(19) United States
(12) Patent Application Publication
(10) Pub. No.: US 2017/0206768 A1
(43) Pub. Date: Jul. 20, 2017

(54) APPARATUS FOR SAVING DROWNING CHILDREN AND SYSTEM COMPRISING THE SAME

(71) Applicant: GACHON UNIVERSITY OF INDUSTRY-ACADEMIC COOPERATION FOUNDATION, Seongnam-si (KR)

(72) Inventor: Young-Im CHO, Seoul (KR)

(21) Appl. No.: 15/351,292

(22) Filed: Nov. 14, 2016

(30) Foreign Application Priority Data
Jan. 15, 2016 (KR) 10-2016-0005213

(51) Int. Cl. G08B 21/08

(52) U.S. Cl. CPC G08B 21/088

(57) ABSTRACT

An apparatus for saving drowning children including an expansion part that is selected and operated to any one of a folded mode and an expansion mode, a manual operation part that is connected to an expansion part receiving unit, a communication module which can communicate with the terminal, a trigger module that triggers the expansion part, and a controller that controls the trigger module, wherein the expansion part is manually triggered when a predetermined motion is performed on the manual operation part or automatically triggered according to a predetermined algorithm by the controller, and the communication module transmits at least some of the data input into the controller to the terminal.

### CROSS-REFERENCE TO RELATED APPLICATIONS

This application claims the priority of Korean Patent Application No. 10-2016-0005213 filed on Jan. 15, 2016, in the Korean Intellectual Property Office, the disclosure of which is incorporated herein by reference.

### BACKGROUND

Field

The present disclosure relates to an apparatus for saving drowning children and a system comprising the same, and more particularly, to an apparatus and a system capable of preventing drowning of children under the age of 14 including infants of the age of 1 to 4 in which a manually or automatically triggered balloon is provided and a drowning children notification pad for a safety guard and a drowning children notification server for a control center are connected.

Description of the Related Art

As modern swimming pools, 6 indoor swimming pools were founded in London in 1897 and in Korea, a YMCA swimming pool completed in 1967 was the first swimming pool. Thereafter, the swimming pools were divided into personal swimming pools, public swimming pools, and game swimming pools according to purposes of use. The personal swimming pools are constructed in homes or private estates for use of family, the public swimming pools are national and private sports centers/resorts/playgrounds/pools, and the game swimming pools are standard sized swimming pools to play sports games such as the Olympic Games.

Recently for the past few years, with the increase of various forms of swimming pools, water activities have become more frequent not only in the summer, but also during the four seasons. Accordingly, in the case where you have a young child, you need to be extra careful with swimming safety and particularly, there is a risk of a drowning accident and thus children who are good at swimming still need to be careful.

Because the drowning takes place quietly in an instant, and the child can be put in a dangerous situation due to momentary carelessness before adults recognize and discover the drowning child, experts give advice to parents that they should constantly keep their eyes on their child when the child is swimming. According to the international child-safety organization, Safe Kids USA, it has been known that an average of 815 children under the age of 14 was killed every year by drowning from 1999 to 2008.

Particularly, it has been known that the drowning of infants of the age of 1 to 4 occurs in the swimming pools, and even if the infants are saved from the water and they survive by cardiopulmonary resuscitation (CPR), the damage to the brain frequently occurs, and thus in order to prevent such accidents from happening, the development of an apparatus and system for saving drowning children is urgently needed.

As the related art for solving the problems, in Korea Patent Application Publication No. 2003-0071411, a rescuing apparatus which allows the drowning children to manually trigger a balloon by wearing the rescuing apparatus on the wrist when they are in a dangerous situation is provided. However, in such a rescuing apparatus, a certain level of understanding for being able to easily learn how to use the apparatus is required, so there is a limit to having young children including infants use the saving apparatus in an unexpected situation. Further, even after the balloon is manually triggered, it is difficult for the drowning children to notify the situation to the safety guards and there is a high chance that immediate rescuing activities would not be performed.

As another related art, in Japanese Patent Laid-Open Publication No 2012-118721, there is provided an alarming system configured such that immediate rescuing activities are performed in the swimming pools. However, in the provided alarming system, there is a problem in that the drowning person cannot escape the dangerous situation before the safety guard actually lifts the drowning person from the water.

Further, the saving apparatus and the alarming system in the related art are generally useful for a subject that can determine the dangerous situation, and actually, it is difficult to operate the saving apparatus or there is a limitation to apply the saving apparatus to children including infants that do not hold their breath before being rescued by the safety guard. Particularly, in the case of the children including the infants, because the chances of passing the golden time of 1 to 4 minutes, which is when life or death is determined is high, more rapid and immediate rescuing activities need to be performed.

Accordingly, a saving apparatus and system through which children including infants may immediately float on the surface of the water and the safety guards can rapidly perform the saving activities are required.

### SUMMARY

An object of the present disclosure is to provide a wearable apparatus and a saving system including the same for saving drowning children including infants, which can be used for communication in order to prevent the drowning of children including infants from occurring in a swimming pool or a place filled with water with a predetermine depth.

Another object of the present disclosure is to provide a saving system that further includes a drowning children notification pad for a safety guard that can communicate with the apparatus for saving drowning children and a drowning children notification server for a control center that can communicate with the drowning children notification pad.

According to an aspect of the present disclosure, there is provided an apparatus for saving drowning children. The apparatus for saving drowning children includes: an expansion part that is selected and operated to any one of a folded mode and an expansion mode; an expansion part receiving unit that accommodates at least a part of the expansion part in the folded mode; a manual operation part that is connected to the expansion part receiving unit; a first plate that is connected to the expansion part receiving unit and includes a communication module which can communicate with a terminal; and a second plate which is connected to the expansion part receiving unit and includes a trigger module triggering the expansion part and a controller controlling the trigger module. Herein, the expansion part is manually triggered when a predetermined motion is performed on the manual operation part or automatically triggered according to a predetermined algorithm by the controller, and the communication module transmits at least some of the data input into the controller to the terminal.

According to another aspect of the present disclosure, there is provided a system for saving drowning children including one or more apparatuses for saving drowning children.

Details of other exemplary embodiments will be included in the detailed description of the invention and the accompanying drawings.

Various advantages and features of the present disclosure and methods accomplishing thereof will become apparent from the following description of embodiments with reference to the accompanying drawings. However, the present disclosure is not limited to exemplary embodiment disclosed herein but will be implemented in various forms. The exemplary embodiments are provided by way of example only so that a person of ordinary skilled in the art can fully understand the disclosures of the present disclosure and the scope of the present disclosure. Therefore, the present disclosure will be defined only by the scope of the appended claims.

Like reference numerals generally denote like elements throughout the present specification. Sizes, locations, connection relationships, and the like of respective components configuring the present disclosure are exaggerated for clarity of this specification. Further, in the description of the present disclosure, when it is determined that the gist of the present disclosure can be blurred by the related known arts, the detailed description thereof will be omitted.

According to the present disclosure, a safety state of children including infants that are playing in water can be determined in real time, and when a child is found drowning, the apparatus for saving drowning children can be manually or automatically operated and thus the drowning child can rapidly float to the surface of the water.

Further, according to the present disclosure, when infants that have difficulties in manually operating the apparatus for saving drowning children are found drowning, a safety guard operates the apparatus for saving drowning children through remote control and thus the infants can rapidly float to the surface of the water.

Further, according to the present disclosure, the apparatus for saving drowning children is manufactured in a small size to be light and wearable and thus the infants can wear it without burden due to weight or fear of injury.

Further, according to the present disclosure, the terminals which can communicate and be used by safety guards to verify locations and drowning states of the children including the infants in real time and when the drowning children occur and are in a dangerous state, immediately, saving activities can be rapidly performed by an alarm on the terminal.

Further, according to the system including the apparatus for saving drowning children of the present disclosure, initial saving in which the drowning children are made to float to the surface of the water by the apparatus for saving drowning children, secondary saving in which safety guards directly save the drowning children from the water, and tertiary saving in which the drowning children are transferred to a 119 ambulance through a control center can be performed by one-stop. Through the rapid one-stop system, the probability that the time for saving the children including the infants passing the golden time of 1 to 4 minutes when life or death is determined can be lowered.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic diagram for describing a structure of an apparatus for saving drowning children according to an exemplary embodiment of the present disclosure.

FIGS. 2A and 2B are schematic diagrams illustrating a folded mode and an expansion mode of the apparatus for saving drowning children according to the exemplary embodiment of the present disclosure, respectively.

FIG. 3 is a schematic diagram for describing a terminal which can communicate with the apparatus for saving drowning children according to the exemplary embodiment of the present disclosure.

FIG. 4 is a schematic diagram for describing an automatically triggered function of the apparatus for saving drowning children according to the exemplary embodiment of the present disclosure.

FIG. 5 is a schematic diagram for describing some functions of the terminal which can communicate with the apparatus for saving drowning children according to the exemplary embodiment of the present disclosure.

FIG. 6 is a schematic diagram for describing a system including the apparatus for saving drowning children according to the exemplary embodiment of the present disclosure.

FIG. 7 is a flowchart for describing a system including the apparatus for saving drowning children according to the exemplary embodiment of the present disclosure.

FIG. 8 is a flowchart for describing a terminal which can communicate with the apparatus for saving drowning children according to the exemplary embodiment of the present disclosure.

FIG. 9 is a flowchart for describing a server which transceives data with the terminal which can communicate with the apparatus for saving drowning children according to the exemplary embodiment of the present disclosure.

### DETAILED DESCRIPTION OF THE PREFERRED EMBODIMENT

Hereinafter, the present disclosure is described in detail with reference to exemplary embodiments illustrated in the accompanying drawings, but the proposed exemplary embodiments are exemplified for a clear understanding of the present disclosure and the present disclosure is not limited thereto.

Terms or words used in this specification and claims should not be interpreted as being limited to typical or dictionary meanings, but should be interpreted as having meanings and concepts which comply with the technical spirit of the present disclosure, based on the principle that an inventor can appropriately define the concept of the term to describe his/her own invention in the best manner.

Particularly, “a drowning children notification pad for a safety guard” disclosed in this specification is a terminal such as smart phones and touch pads which can communicate with each other and referred to as a terminal interlocking with an apparatus for saving drowning children according to an exemplary embodiment of the present disclosure.

Further, “a drowning children notification server for a control center” is a server connected with the drowning children notification pad for the safety guard and referred to as a server of a control center which manages and controls facilities and safety of a swimming place such as a swimming pool, a water park, and a beach.

Throughout the specification and the claims, unless explicitly described to the contrary, the word “comprise” and variations such as “comprises” or “comprising” will be understood to imply the inclusion of stated elements but not the exclusion of any other elements. In addition, the terms “-part”, “-or(er)”, “module” and “device” described in the specification mean units for processing at least one function and operation and can be implemented by hardware components or software components and combinations thereof.

Hereinafter, technical configurations of the present disclosure will be described below in detail according to preferred exemplary embodiments.

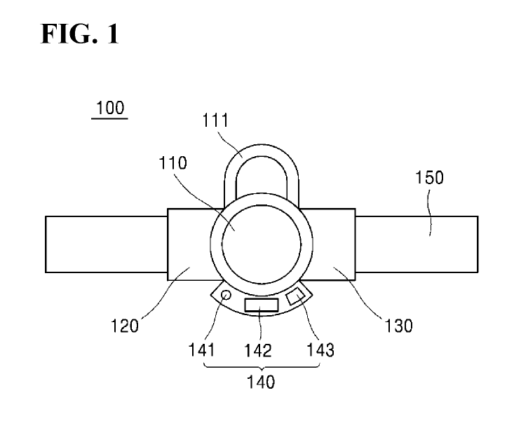

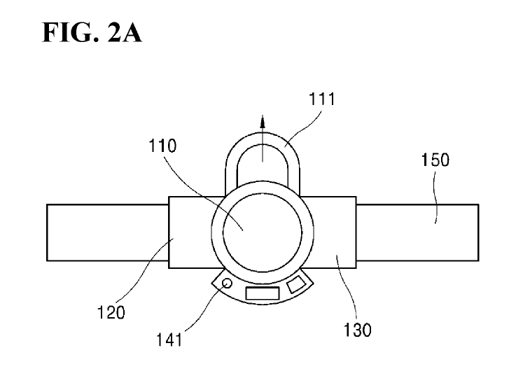

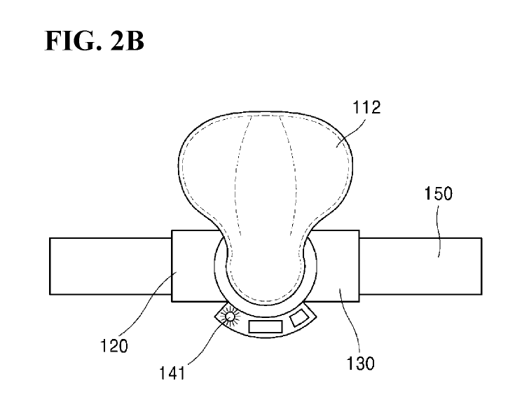

First, an entire configuration of an apparatus 100 for saving drowning children according to the present disclosure will be described with reference to FIGS. 1 to 2B.

The apparatus 100 for saving drowning children of the present disclosure includes an expansion part receiving unit 110, a first plate 120, a second plate 130, a display unit 140, and an attachment means 150. In this case, the first plate 120, the second plate 130, the display unit 140, and the attachment means 150 may be connected with at least a part of the expansion part receiving unit 110.

The expansion part receiving unit 110 is connected with a manual operation part 111 and an expansion part 112 and selected in any one of a folded mode and an expansion mode. When the operated expansion part 112 is in the folded mode, at least a part of the expansion part 112 is received in the expansion part receiving unit 110. The expansion part receiving unit 110 may have a hollow circular drum shape, but is not limited to any shape.

The manual operation part 111 is connected to one side of the expansion part receiving unit 110 to have a ring shape so as to be easily pulled, but is not limited to any one shape. In this case, while the manual operation part 111 is pulled in a direction (see an arrow A direction of FIG. 2A) away from one side of the expansion part receiving unit 110, a part of an upper side of the expansion part receiving unit 110 is opened and then the expansion part 112 protrudes from the expansion part receiving unit 110 to be operated to be expanded (see FIG. 2B).

The expansion part 112 may be formed to be expanded in a shape which can be easily grasped by children including infants or easily support weights of children including infants. Particularly, in the case of the infants, the expansion part 112 may be expanded to be formed so that their head can easily float above the surface of the water. For example, the expansion part 112 may be expanded to cover the waist of the infant and a part of the lower body (like a seat) or attached between the arm and the body to support the armpit when floating.

Both the first plate 120 and the second plate 130 are connected with the expansion part receiving unit 110, and preferably, the first plate 120 is connected to a part of the top of the expansion part receiving unit 110 and the second plate 130 is connected to a part of the bottom of the expansion part receiving unit 110. Thus, a part of the first plate 120 may be formed to configure an upper layer with respect to a part of the second plate 130. A more compact saving apparatus may be configured due to the shape.

The first plate 120 may include a chargeable battery that supplies power and the second plate 130 may include a charging part for charging the battery. Accordingly, the apparatus 100 for saving drowning children can be reused through charging and the charging part may be formed to be compatible with a battery charger which is generally used, and particularly, may be connected with a cover having a water-proof function so that safe water activities are possible.

The first plate 120 may further include at least one of an electronic money module (not illustrated) or a locker key module (not illustrated). The first plate 120 may be configured such that an NFC chip is provided on at least a part to enable electronic payment or lock and unlock of the locker. Accordingly, in facilities such as a swimming pool or a water park, convenient purchase and management of the locker are possible without an additional locker key.

The second plate 130 may further include a trigger module and a gas cylinder (not illustrated) connected with the expansion part 112. When the expansion part 112 is triggered, the gas filling the gas cylinder, preferably, carbon dioxide, moves to the expansion part 112 and the expansion part 112 may be operated in the expansion mode.

Further, the first plate 120 includes a communication module (not illustrated) which can communicate with a terminal and the second plate 130 may include a trigger module (not illustrated) triggering the expansion part 112 and a controller (not illustrated) controlling the trigger module.

In this case, the communication module may be a Zigbee module and as a result, a system in which data is rapidly transmitted to a plurality of terminals from the apparatus 100 for saving drowning children in a wide area can be constructed. Particularly, in the Zigbee module, power consumption is relatively lower than other types of communication modules and thus, the lifespan of the battery of the apparatus 100 for saving drowning children can be increased.

Further, a plurality of apparatuses 100 for saving drowning children and the plurality of terminals can communicate with each other to establish a communication network in the wide area, and as a result, the children are monitored by a plurality of safety guards and when the drowning occurs, a safety guard which is closest to the drowning children among the plurality of safety guards can rapidly save the drowning children.

The expansion part 112 is manually triggered when a predetermined operation is performed on the manual operation part 111 or automatically triggered according to a predetermined algorithm by the controller. In this case, the predetermined motion may be an operation in which the manual operation part 111 is pulled in the direction away from one side of the expansion part receiving unit 110. However, in another exemplary embodiment, when the manual operation part 111 is a button, the predetermined motion may be a pressing motion, and in yet another exemplary embodiment, when the manual operation part 111 is a lever, the predetermined motion may be an operation of rotating or vertically moving the lever.

Further, the predetermined algorithm may be an algorithm which operates the trigger module by an interaction between the communication module and the controller. Alternatively, the predetermined algorithm may be an algorithm in which the data input into the controller is calculated to operate the trigger module according to a predetermined standard and the expansion part 112 is automatically triggered.

More particularly, in the case where the communication module and the controller interact with each other, the data input into the controller is transmitted to the terminal and the apparatus 100 for saving drowning children according to the exemplary embodiment of the present disclosure is remotely controlled by using the terminal to be controlled such that the trigger module is operated without operating the manual operation part 111 and then the expansion part 112 is automatically triggered.

In this case, the data input into the controller is data including drowning state information representing a risk degree due to drowning of a subject wearing the apparatus 100 for saving drowning children, and the drowning state information may be any one of a dangerous state, a cautious state, or a safe state.

The drowning state information may be calculated and provided from a measurement value measured by a sensor including at least one of a water pressure sensor, a motion sensor, a timer, or a positioning sensor. Herein, the sensor is a configuration included in the second plate 130 and may be connected with the controller of the second plate 130 to be operated.

When the data input into the controller is calculated and the trigger module is operated according to the predetermined standard, the predetermined standard may be defined as a case where the drowning state information is determined as the dangerous state. In spite of the dangerous state, if the predetermined motion is not performed on the manual operation part 111, the trigger module is automatically operated and the expansion part 112 is triggered. Accordingly, while the expansion part 112 is triggered, the expansion part 112 is automatically expanded to be operated in the expansion mode.

The display unit 140 may be formed to be connected to one side of the expansion part receiving unit 110 and include at least one of a light emitting unit 141, a watch 142, and a charging state display unit 143. Particularly, the light emitting unit 141 may be configured such that any one of one or more colors, for example, any one of red, yellow, and green is selectively emitted according to the drowning state information of the subject wearing the apparatus 100 for saving drowning children.

Any one of a plurality of colors is selectively emitted according to the drowning state information and thus the drowning state information of the subject may be more easily displayed. More particularly, when the drowning state information is displayed in any one state of the dangerous state, the cautious state, or the safe state, the light emitting unit 141 may be emitted to, for example, red, yellow, or green, respectively.

Further, the apparatus 100 for saving drowning children according to the exemplary embodiment of the present disclosure may be configured such that an alarm means including at least one of sound, vibration, or light of the terminal is operated by inducing a drowning children occurrence alarm on the terminal when the drowning state information is the dangerous state.

When the subject wearing the apparatus 100 for saving drowning children is determined as being in the dangerous state according to the sensor of the controller, an occurrence alarm is induced on the terminal and thus all of the safety guards may immediately recognize a drowning children occurrence situation.

The attachment means 150 is connected to both sides of the expansion part receiving unit 110 and may be a band type in which a length can be controlled so that the apparatus 100 for saving drowning children is easily wearable. In other exemplary embodiment, the attachment means 150 may be configured to be attachable to swimsuits or clothes of wearers, or configured to be fixed to the wrist, the waist, both thighs, arms, and the like. Accordingly, the children including the infants may easily wear the apparatus 100 for saving drowning children.

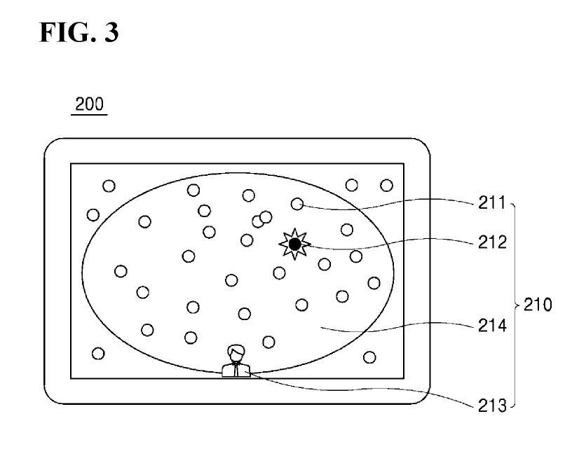

A system including the apparatus 100 for saving drowning children according to the exemplary embodiment of the present disclosure will be described in further detail with reference to FIGS. 3 to 9.

First, interaction and an operational principle of the terminal which can communicate with the apparatus 100 for saving drowning children according to the exemplary embodiment of the present disclosure will be described with reference to FIGS. 3 to 5. Hereinafter, such a terminal is referred to as a drowning children notification pad 200 for a safety guard.

FIG. 3 is a schematic diagram for describing the drowning children notification pad 200 for a safety guard which can communicate with the apparatus for saving drowning children according to the exemplary embodiment of the present disclosure. The drowning children notification pad 200 for the safety guard may be a terminal with a digital screen. One or more drowning children notification pads 200 for the safety guard interlock with one or more apparatuses 100 for saving drowning children and locations of the respective apparatuses 100 for saving drowning children and drowning state information may be displayed on the digital screen by communication modules of the respective apparatuses 100 for saving drowning children.

The drowning children notification pad 200 for the safety guard may operate by receiving data input into the controller from the sensor of the apparatus 100 for saving drowning children through the communication module. On an initial screen 210 of the drowning children notification pad 200 for the safety guard, each of the apparatuses 100 for saving drowning children may be displayed as a wearer state indicator 211.

According to data including the drowning state information transmitted from the apparatus 100 for saving drowning children, the display of the apparatus 100 for saving drowning children displayed on the digital screen may be varied. For example, when the drowning state information is detected as the dangerous state, the wearer state indicator 211 of the corresponding apparatus 100 for saving drowning children may be changed to be shown as a drowning children occurrence indicator 212 on the initial screen 210 of the drowning children notification pad 200 to the safety guard.

Further, on the initial screen 210, a swimming pool display 213 and a safety guard display 214 may be displayed. Accordingly, a location of the apparatus 100 for saving drowning children can be more easily determined and who the closest safety guard is can be more easily determined.

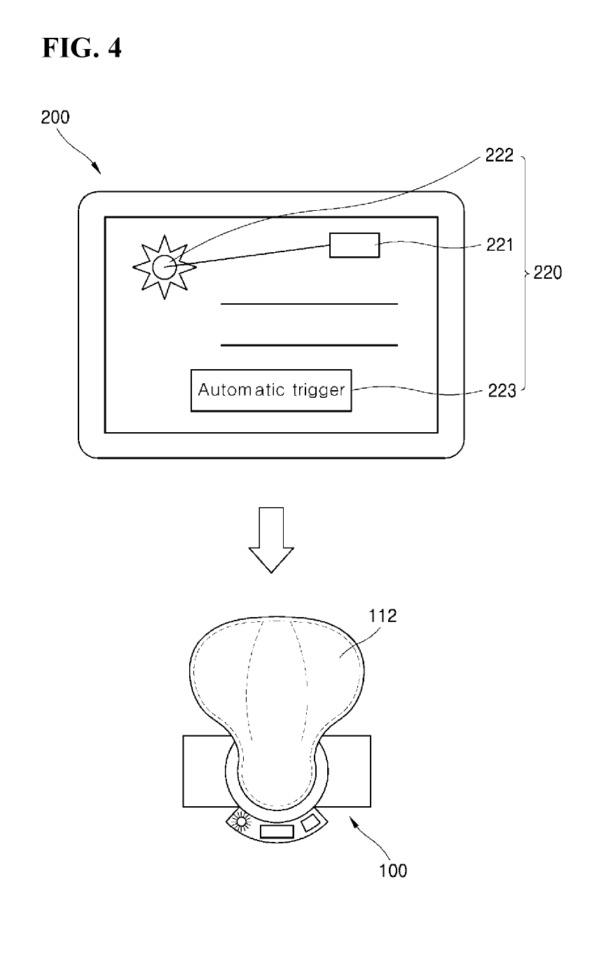

An automatic trigger function of the apparatus for saving drowning children according to the exemplary embodiment of the present disclosure will be described with reference to FIG. 4. When the apparatus 100 for saving drowning children detects that a drowning children occurs, a screen may move to a remote control screen 220 including a drowning children information display 221, a drowning children state display 222, and an automatic trigger icon 223.

The drowning children information display 221 may include information about a name, an age, and an address of the drowning children and the drowning children state display 222 may display the drowning state information transmitted from the apparatus 100 for saving drowning children. Further, the automatic trigger icon 223 may be configured to be remote-controlled such that when the trigger module of the apparatus 100 for saving drowning children is not operated, in an emergency situation, separately, a safety guard presses the automatic trigger icon 223 to operate the trigger module.

When the trigger module is operated, the expansion part 112 is triggered and expanded and then in the emergency situation, even when the children including the infants do not directly operate the manual operation part 111 or the apparatus 100 for saving drowning children is not automatically triggered according to a predetermined algorithm, the children including the infants may be safely floated on the surface by using the expansion part 112.

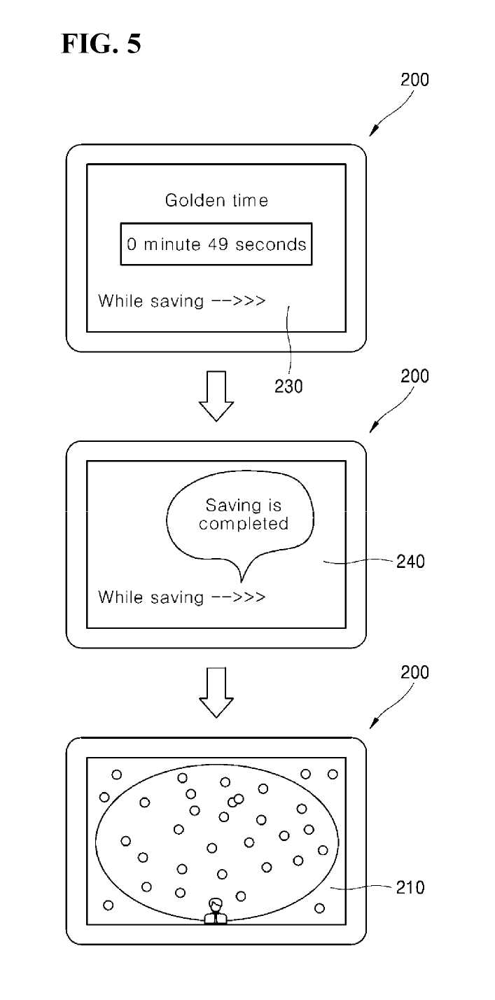

Some functions of the drowning children notification pad 200 for the safety guard which can communicate with the apparatus for saving drowning children according to the exemplary embodiment of the present disclosure will be described with reference to FIG. 5. The drowning children notification pad 200 for the safety guard may further include a screen such as a golden time screen 230 and a saving complete screen 240 in addition to the above configurations.

Through the golden time screen 230, the data transmitted from the apparatus 100 for saving drowning children is calculated in real time, and substantially, the risk degree of the subject wearing the apparatus 100 for saving drowning children may be displayed on the digital screen by a time counting method. Thereafter, when the saving is completed, the screen may move to the saving complete screen 240 and then move to the initial screen 210 again. Thus, other safety guards may know of the drowning children saving situation.

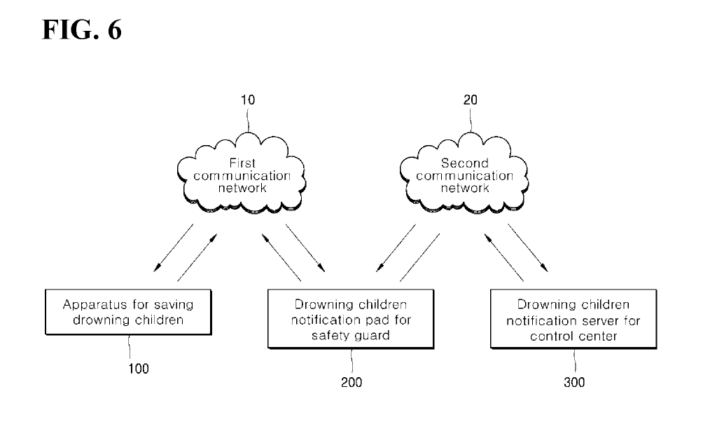

The system including the apparatus for saving drowning children according to the exemplary embodiment of the present disclosure will be described in more detail with reference to FIGS. 6 to 9.

The apparatus 100 for saving drowning children and the drowning children notification pad 200 for the safety guard may transceive the data through the first communication network 10. The first communication network 10 may be a communication network formed by a communication module such as a Zigbee module.

The system including the apparatus 100 for saving drowning children according to the exemplary embodiment of the present disclosure may further include a server that can transceive the data with the drowning children notification pad 200 for the safety guard. The server may be a server configured to enable the drowning children to be rapidly saved in a control center, and hereinafter, such a server will be referred to as the drowning children notification server 300 for the control center.

It is preferable that the drowning children notification server 300 for the control center can communicate with the drowning children notification pad 200 for the safety guard through a second communication network 20, and the communication network 20 may be for example, a communication network formed through WiFi.

The data transmitted to at least one drowning children notification pad 200 for the safety guard by each communication module may be transmitted to the drowning children notification server 300 for the control center by the drowning children notification pad 200 for the safety guard through the first communication network 10 and the second communication network 20.

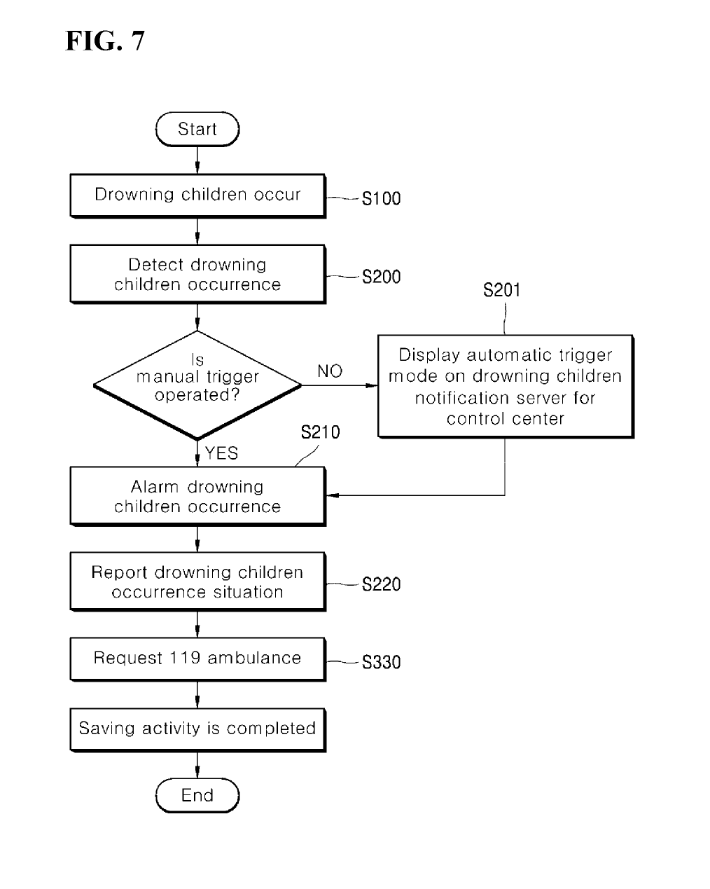

An operational process of the system including the apparatus 100 for saving drowning children according to the exemplary embodiment of the present disclosure will be described with reference to FIG. 7. First, when the drowning of the children including the infants wearing the apparatus 100 for saving drowning children occurs (S100), the sensor of the apparatus 100 for saving drowning children detects the drowning children occurrence according to the data input into the controller (S200). In this case, in the apparatus 100 for saving drowning children which transmits the data in which the drowning children occurrence of the children is detected, the controller verifies whether the manual trigger occurs by the manual operation part 111.

When the manual trigger does not occur, the automatic trigger mode is displayed on the drowning children notification pad 200 for the safety guard (S201). The automatic trigger mode may be any one of a mode in which the trigger module of the apparatus 100 for saving drowning children is automatically operated through a predetermined algorithm and then the expansion part 112 is triggered or expanded, or a mode in which the trigger module is controlled by the drowning children notification pad 200 for the safety guard and then the expansion part 112 is triggered or expanded by remote control.

While the expansion part 112 is triggered or expanded by manual trigger or automatic trigger, a drowning children occurrence alarm is operated in the drowning children notification pad 200 for the safety guard (S210), and the drowning children occurrence situation is automatically reported to the drowning children notification server 300 for the control center (S220). When the drowning children occurrence situation is reported, the drowning children notification server 300 for the control center automatically requests a 119 ambulance (S330), and the saving activity may be rapidly performed and completed.

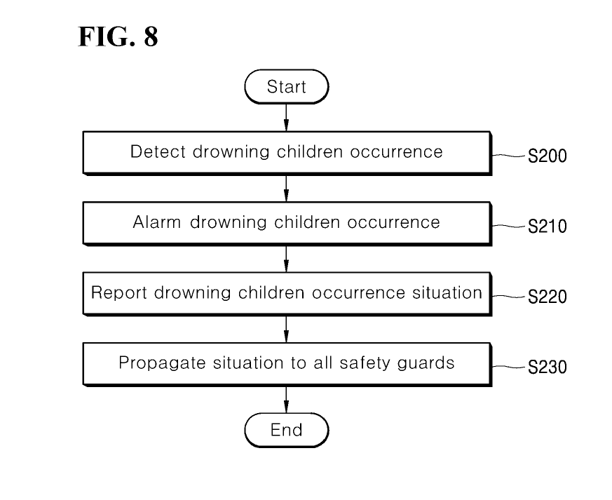

An operating process of the drowning children notification pad 200 for the safety guard which can communicate with the apparatus 100 for saving drowning children according to the exemplary embodiment of the present disclosure will be described in more detail with reference to FIG. 8. When the drowning children occurrence is detected (S200), the drowning children occurrence alarm is operated (S210), the drowning children occurrence situation is reported to the control center (S220), and the situation is propagated to all of the safety guards through the drowning children notification pad 200 for the safety guard (S230).

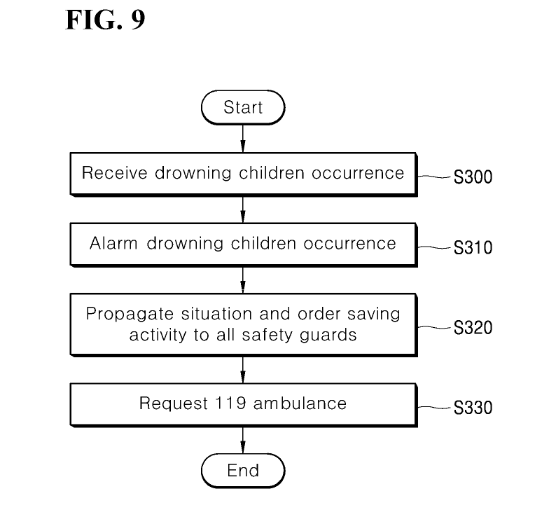

The drowning children notification server 300 for the control center which transmits and receives the data with the drowning children notification pad 200 for the safety guard that can communicate with the apparatus for saving drowning children according to the exemplary embodiment of the present disclosure will be described with reference to FIG. 9.

When the drowning children occurrence situation is received from the drowning children notification pad 200 for the safety guard (S300), the drowning children occurrence alarm is operated in the control center (S310), the propagation situation and the saving activity indication are transmitted to all of the safety guards (S320), and the 119 ambulance is automatically requested (S330).

In the control center, it is preferable that as the drowning children occurrence alarm, an alarming means including at least one of sound, vibration, or light of the drowning children notification server 300 for the control center may be operated.

As such, the drowning children notification pad 200 for the safety guard interlocking the apparatus 100 for saving drowning children and the drowning children notification server 300 for the control center which transceives the data with the drowning children notification pad 200 for the safety guard are configured, and thus the saving activities of the children including the infants can be more rapidly performed.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only but not intended to limit the technical concept of the present disclosure. The scope of the technical concept of the present disclosure is not limited thereto. Therefore, it should be understood that the above-described exemplary embodiments are illustrative in all aspects and do not limit the present invention. The protective scope of the present disclosure should be construed based on the following claims, and all the technical concepts in the equivalent scope thereof should be construed as falling within the scope of the present disclosure.

What is claimed is:

1. An apparatus for saving drowning children, comprising:
an expansion part that is selected and operated to any one of a folded mode and an expansion mode;
an expansion part receiving unit that accommodates at least a part of the expansion part in the folded mode;
a manual operation part that is connected to the expansion part receiving unit;
a first plate that is connected to the expansion part receiving unit and includes a communication module which can communicate with a terminal; and
a second plate which is connected to the expansion part receiving unit and includes a trigger module triggering the expansion part and a controller controlling the trigger module,
wherein the expansion part is manually triggered when a predetermined motion is performed on the manual operation part or automatically triggered according to a predetermined algorithm by the controller, and
the communication module transmits at least some of the data input into the controller to the terminal.

2. The apparatus for saving drowning children of claim 1,
wherein the expansion part is automatically triggered by the trigger module by interaction between the communication module and the controller.

3. The apparatus for saving drowning children of claim 1,
wherein the data includes drowning state information,
and the terminal is operated according to the drowning state information transmitted from the communication module.

4. The apparatus for saving drowning children of claim 3,
wherein the drowning state information includes any one state out of, a dangerous state, a cautious state, or a safe state.

5. The apparatus for saving drowning children of claim 3,
wherein the second plate further includes a sensor connected with the controller, the sensor including at least one of a water pressure measurement sensor, an operation sensor, a timer, and a positioning sensor,
and the drowning state information is provided by calculating measurement values measured by the sensor according to a predetermined standard.

6. The apparatus for saving drowning children of claim 4,
wherein when the drowning state information is the dangerous state,
and an alarm means including at least one of sound, vibration, or light of the terminal is operated by inducing a drowning children occurrence alarm on the terminal.

7. The apparatus for saving drowning children of claim 4,
wherein when the drowning state information is the dangerous state and the predetermined motion is not performed by the manual operation part, the expansion part is automatically operated in the expansion mode.

8. The apparatus for saving drowning children of claim 4, further comprising:
a display unit connected to one side of the expansion part receiving unit,
wherein the display unit includes at least one of a light emitting unit, a watch, and a charging state display unit, and
the light emitting unit selectively emits any one of one or more colors according to the drowning state information.

9. The apparatus for saving drowning children of claim 1, further comprising:
an attachment means connected to both sides of the expansion part receiving unit,
wherein the attachment means is a band type of which a length is controlled.

10. The apparatus for saving drowning children of claim 1,
wherein the first plate includes a chargeable battery that supplies power and the second plate includes a charging part for charging the battery.

11. The apparatus for saving drowning children of claim 1,
wherein the first plate further includes at least one of an electronic money module or a locker key module,
and an NFC chip is provided on at least a part of the first plate to enable electronic payment or locking and unlocking of the locker.

12. The apparatus for saving drowning children of claim 1,
wherein the second plate further includes a trigger module and a gas cylinder connected with the expansion part,
and when the expansion part is triggered, gas filled in the gas cylinder moves to the expansion part and the expansion part is operated in the expansion mode.

13. A system for saving drowning children comprising the apparatus for saving drowning children according to claim 1.

14. The system for saving drowning children of claim 13, further comprising:
one or more terminals interlocking with communication modules of one or more apparatuses for saving drowning children and a server transceiving the data with one or more terminals,
wherein the data transmitted to one or more terminals is transmitted to the server by the terminal through each communication module.

15. The system for saving drowning children of claim 14,
wherein the terminal is a terminal with a digital screen and a location of each apparatus for saving drowning children is displayed on the digital screen,
and at least some of the data input into the controller of the apparatus for saving drowning children are transmitted to the terminal by the communication module and a display of the apparatus for saving drowning children displayed on the digital screen varies according to the data.

16. The system for saving drowning children of claim 14,
wherein drowning children occurrence is detected according to the data input into the controller of the apparatus for saving drowning children,
the apparatus for saving drowning children transmitting the data in which the drowning children occurrence is detected among the apparatuses for saving drowning children is controlled by the terminal to automatically trigger the expansion part by remote control.

17. The system for saving drowning children of claim 14,
wherein the server is a server used in a control center and when the drowning children occur, the drowning children occurrence situation is reported to the control center by the terminal.

18. The system for saving drowning children of claim 17,
wherein when the drowning children occurrence situation is reported to the server, a drowning children occurrence alarm is induced in the server and an alarm means including at least one of sound, vibration, or light of the terminal is operated.

19. The system for saving drowning children of claim 17,
wherein when the drowning children occurrence situation is reported to the server, a saving order is transmitted to the terminal.

20. The system for saving drowning children of claim 17,
wherein when the drowning children occurrence situation is reported to the server, a request for an ambulance is automatically transmitted to a 119 center.
